(19) United States
(12) Patent Application Publication
(10) Pub. No.: US 2015/0046479 A1
(43) Pub. Date: Feb. 12, 2015

(54) COLLABORATIVE FILTERING RECOMMENDATIONS USING IMPLICIT USER ACTIONS

(71) Applicant: VIDMIND LTD., Tel-Aviv (IL)

(72) Inventors: Eyal ALLWEIL, Tel-Aviv (IL); Alex Tenenbaum, Shoham (IL); Ofer Herman, Ein-Sarid (IL)

(73) Assignee: VIDMIND LTD., Tel-Aviv (IL)

(21) Appl. No.: 13/961,895

(22) Filed: Aug. 8, 2013

(51) Int. Cl. G06F 17/30

(52) U.S. Cl. CPC G06F 17/30699
USPC 707/754

(57) ABSTRACT

A method of collaborative filtering recommendations using implicit user actions is provided herein. The method includes the following steps: collecting user preference of content items from the crowd; generating for each real content item, a shadow content item; updating preference for the shadow items based on the user preference of corresponding real content items; feeding a collaborative recommendation engine a list of content items and their corresponding preferences, wherein the list comprises both real and shadow content items; and filtering out the shadow content items from an output of the recommendation engine, to yield a list of recommended real content items.

### BACKGROUND OF THE INVENTION

1. Technical Field

The present invention relates to content mining and more specifically to recommendation engines.

2. Discussion of the Related Art

Collaborative Filtering frameworks (for example, Apache Mahout) can be used to recommend items to users based on their past preferences. Such systems may be based on either explicit or implicit user preferences. One example of an explicit user preference is a numerical rating given to an item, such as a score on a music review web site. An example of an implicit user preference might be the fact that a user watched a movie, or posted information pertaining to the movie on a social network.

A major problem in using implicit user actions to recommend items is that the existence of a user preference for an item will prevent a recommendation system from recommending that item. However, some actions are indicative of a user's preferences, but should not prevent a recommendation for that item. An example of this is if a user chose to watch a preview for an unreleased movie. Clearly, the recommendation system should still be able to suggest this movie for the user.

It would be, therefore, advantageous to provide a platform that is capable taking into account implicit actions of users in regards with specified content items while still be able to recommend the specified content items to those users, based on the collaborative filtering principles.

### SUMMARY OF THE INVENTION

One aspect of the invention provides a method of collaborative filtering recommendations using implicit user actions. The method includes the following steps: collecting user preference about content items from the crowd; generating for each real content item, a shadow content item; updating preference for the shadow items based on the user preference of corresponding real content items; feeding a collaborative recommendation engine a list of content items and their corresponding preferences, wherein the list comprises both real and shadow content items; and filtering out the shadow content items from an output of the recommendation engine, to yield a list of recommended real content items.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating the system according to some embodiments of the invention;

FIG. 2 is a high level flowchart illustrating an aspect according to some embodiments of the invention; and

FIG. 3 is a diagram illustrating an aspect in accordance with some embodiments of the present invention.

The drawings together with the following detailed description make apparent to those skilled in the art how the invention may be embodied in practice.

### DETAILED DESCRIPTION OF THE INVENTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

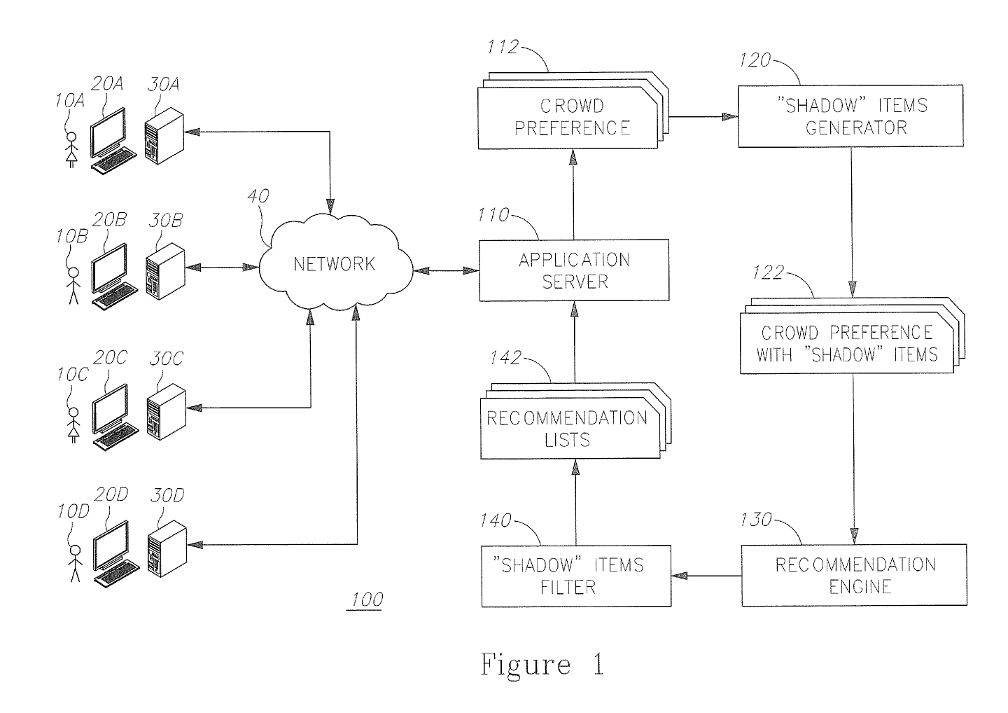

FIG. 1 is a high level schematic block diagram illustrating an environment of a system according to some embodiments of the invention. A plurality of users/subscribers 10A-100 are logged onto a network 40 via a plurality of client computers 30A-30D, each associated with a respective display 20A-20D. users/subscribers 10A-10D may be connected (independently) to various social networks and are active in various websites so that each one of the users may be associated with a profile. An application server 110 is accessible by any of client computers 30A-30D, via network 40. Application server 110 is in operative association with a “shadow” items generator 120 which is fed with a crowd preference 125 originated by content items rating of users/subscribers 10A-10D. Application server 110 is further in operative association with a recommendation engine 130 which is fed with crowd preference with shadow items 122 and is configured to generate a list of recommended items that includes shadow items. Application server 110 is in operative association with “shadow” items filter 140 which filters out the shadow items, to yield a list of recommended item that holds only real content items 142.

In operation, application server 110 is configured to collect user preference of content items from the crowd, possibly with their profile. Shadow item generator 120 is configured to generate for each real content item, a shadow content item. A collaborative recommendation engine 130 is configured to receive a list of content items and their corresponding preferences, wherein the list comprises both real and shadow content items. A filter unit 140 is configured to filter out the shadow content items from the output of the recommendation engine, to yield a list of recommended real content items. The shadow item generator 120 is further configured to update preference for the shadow items based on the user preference of corresponding real content items. Specifically, two types of preferences are provided: implicit and explicit. As implicit preferences only the shadow items are accounted for whereas as explicit preference both real items and shadows are accounted for. Consequently, the explicit votes create high correlation between the real item and the shadow item.

Following is a non limiting example of the benefits of the embodiments of the present invention. User 10B who has seen the movies The Matrix and The Matrix Reloaded, and seen a trailer for The Matrix Revolutions and “liked” the Facebook page of The Animatrix. It is assumed that that there is a large number of Matrix fans associated with application server 110, all of whom have given very positive scores to all the Matrix movies. Therefore, since the user has preferences on the shadow item he will still receive the real item as recommended and would not be deprived of it as would be the case with currently available recommendation engines.

For each movie associated with application server 110, a single “shadow” movie representing preferences which should not rule out recommendations is generated by generator 120. For every user with a preference X for The Matrix, application server 110 will add a preference of equal weight to its shadow. The computational price of this addition is relatively small since the number of items is usually far less than the number of users. For Bob's preferences, application server 110 will add a positive rating for the shadow items of The Matrix Revolutions and The Animatrix. When getting recommendations, filter unit 140 will filter out shadow items so that only “regular” items can be recommended. The so called “filtering” will be carried out by converting the shadow item into the corresponding real item and then going over the items to make sure that there are no duplicates, in order to prevent recommendation engine 130 from outputting both the real item and the shadow item.

Advantageously, the aforementioned solution ensures a high correlation between items and their shadows that will allow better recommendations without spending the manpower to create a domain-specific work (such as a content-aware recommendation system). The quality is increased but the solution remains generic.

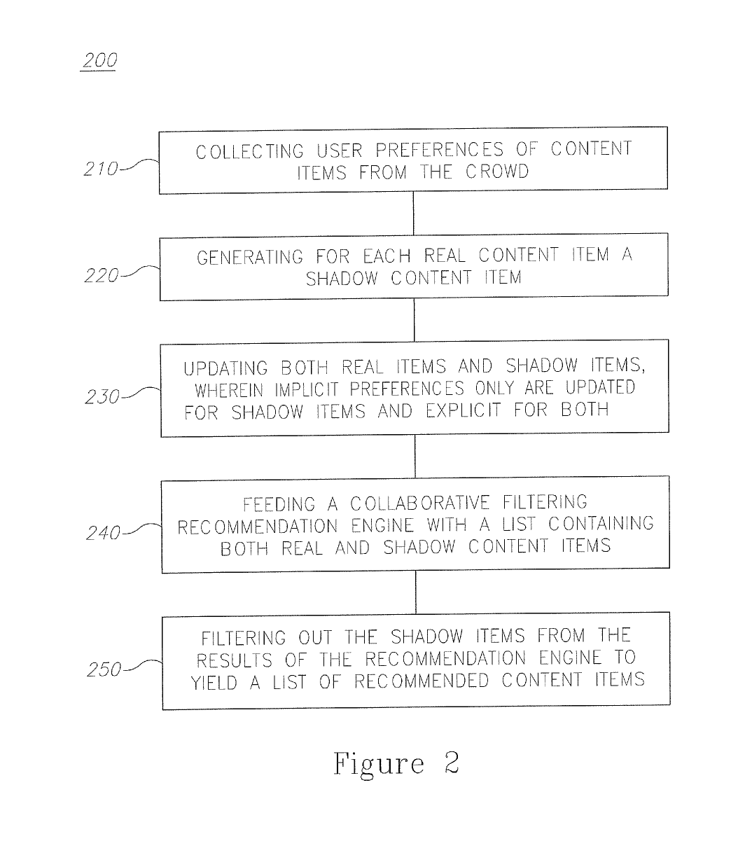

FIG. 2 is a high level flowchart illustrating an aspect according to some embodiments of the invention. Method 200 may be implemented by any architecture and should not be regarded as limited to the aforementioned architecture of system 100. Method 200. Method 200 includes the following steps: collecting user preference of content items from the crowd 210; generating for each real content item, a shadow content item 220; Updating both real items and shadow items, wherein Implicit preferences only are updated for shadow items and explicit for both updating preference for the shadow items based on the user preference of corresponding real content items 230; feeding a collaborative recommendation engine a list of content items and their corresponding preferences, wherein the list comprises both real and shadow content items 240; and filtering out the shadow content items from an output of the recommendation engine, to yield a list of recommended real content items 250.

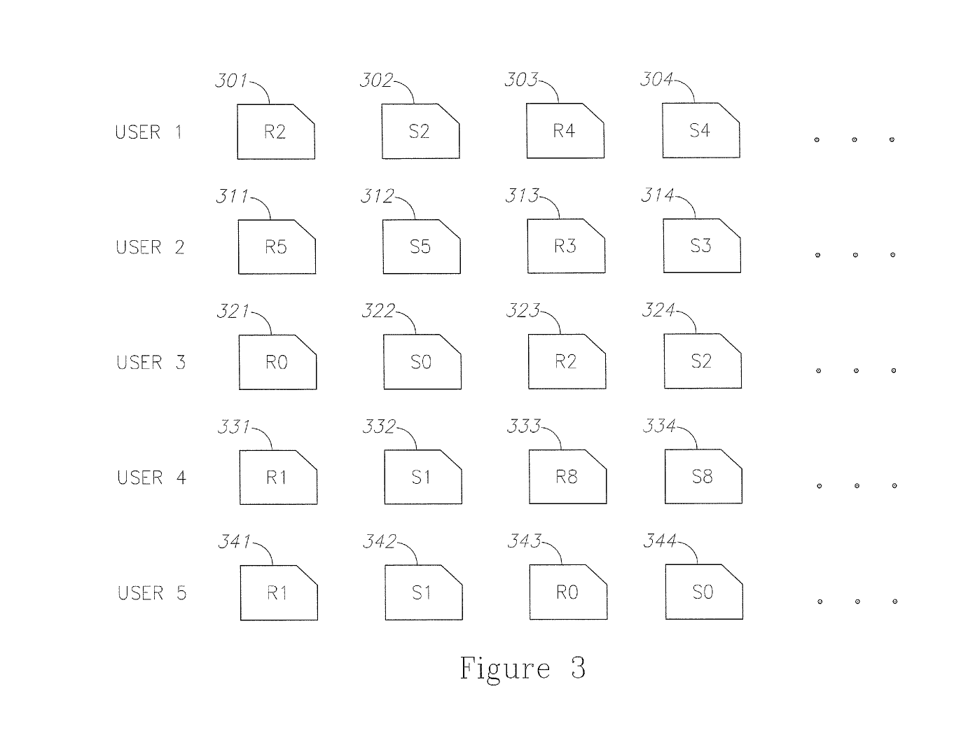

FIG. 3 is a diagram illustrating an aspect in accordance with some embodiments of the present invention. A non limiting example of implementing the shadow generating is simply by adding an identical shadow tag (312-342 and 314-344) for each one of real item tags (311-341 and 313-343). As illustrated, each tag, whether real or shadow is provided with a corresponding rating (R5 means that the rating for the real item is 5 and S0 means that the shadow items received no rating at all). The aforementioned implementation maintains in minimum the additional computational overhead for implementing the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
collecting user preference of content items from the crowd via client computers;
generating for each real content item, a shadow content item;
updating preference for the shadow items based on the user preference of corresponding real content items;
feeding a collaborative recommendation engine a list of content items and their corresponding preferences, wherein the list comprises both real and shadow content items; and
filtering out the shadow content items from an output of the recommendation engine, to yield a list of recommended real content items.

2. The method according to claim 1, wherein the list of content items and their corresponding preferences, that comprises both real and shadow content items is indicative of user preferences deduced from both explicit and implicit users actions.

3. The method according to claim 1, wherein user preference are represented by quantitative scores.

4. The method according to claim 1, wherein each one of the users is associated with a profile that is used by the recommendation engine.

5. A system comprising:
an application server, executed by a computer processor, configured to collect user preference of content items from the crowd;
a shadow item generator configured to generate for each real content item, a shadow content item;
a collaborative recommendation engine configured to receive a list of content items and their corresponding preferences, wherein the list comprises both real and shadow content items; and
a filter unit configured to filter out the shadow content items from the output of the recommendation engine, to yield a list of recommended real content items, wherein the application server is further configured to update preference for the shadow items based on the user preference of corresponding real content items.

6. The system according to claim 5, wherein the list of content items and their corresponding preferences, that comprises both real and shadow content items is indicative of user preferences deduced from both explicit and implicit users actions.

7. The system according to claim 5, wherein user preference are represented by quantitative scores.

8. The system according to claim 5, wherein each one of the users is associated with a profile that is used by the recommendation engine.

9. A computer program product comprising: a non-transitory computer readable storage medium having computer readable program embodied therewith, the computer readable program comprising:
computer readable program configured to collect user preference of content items from a crowd;
computer readable program configured to generate for each real content item, a shadow content item;
computer readable program configured to receive a list of content items and their corresponding preferences, wherein the list comprises both real and shadow content items;
computer readable program configured to filter out the shadow content items from, to yield a list of recommended real content items; and
computer readable program configured to update preference for the shadow items based on the user preference of corresponding real content items.

10. The computer program product according to claim 9, wherein the list of content items and their corresponding preferences, that comprises both real and shadow content items is indicative of user preferences deduced from both explicit and implicit users actions.

11. The computer program product according to claim 9, wherein user preference are represented by quantitative scores.

12. The computer program product according to claim 9, wherein each one of the users is associated with a profile used for recommending.
